(19) United States
(12) Patent Application Publication
(10) Pub. No.: US 2026/0008366 A1
(43) Pub. Date: Jan. 8, 2026

(54) POWER SUPPLY SYSTEM

(71) Applicant: TOYOTA JIDOSHA KABUSHIKI KAISHA, Toyota-shi (JP)

(72) Inventor: Jinwoo KIM, Toyota-shi (JP)

(73) Assignee: TOYOTA JIDOSHA KABUSHIKI KAISHA, Toyota-shi (JP)

(21) Appl. No.: 19/074,960

(22) Filed: Mar. 10, 2025

(30) Foreign Application Priority Data
Jul. 3, 2024 (JP) 2024-107654

(51) Int. Cl. B60L 53/24; B60L 53/16; B60R 16/08

(52) U.S. Cl. CPC B60L 53/24; B60L 53/16; B60R 16/08; B60L 2210/40; B60L 2240/526; B60L 2240/545

(57) ABSTRACT

A power supply system includes: a motor including a three-phase coil; first and second inverters connected to first and second batteries via first and second positive lines and a negative line, respectively, and connected to one end and another end of the three-phase coil, respectively; a charging connector and auxiliary equipment connected to the first positive line and the negative line; a temperature adjustment device that adjusts the temperature of the first and second batteries using a temperature adjustment medium; and a control device that, when performing parallel charging, controls the first and second inverters so that the first and second batteries are charged within the range of first and second allowable input powers that are based on first and second temperatures of the first and second batteries, respectively. The temperature adjustment device has a higher temperature adjustment capability for the first battery than for the second battery.

### CROSS-REFERENCE TO RELATED APPLICATION

This application claims priority to Japanese Patent Application No. 2024-107654 filed on Jul. 3, 2024. The disclosure of the above-identified application, including the specification, drawings, and claims, is incorporated by reference herein in its entirety.

### BACKGROUND

### 1. Technical Field

The present disclosure relates to power supply systems.

### 2. Description of Related Art

Conventionally, there has been proposed a power supply system that includes an energy storage device and an inlet. The energy storage device includes a first battery, a second battery, and a switching relay configured to switch between a first state in which the first battery and the second battery are connected in series and a second state in which the first battery and the second battery are connected in parallel. The inlet is connected to a positive line and a negative line that connect the energy storage device and a power control unit (PCU) configured to drive a motor. For example, see Japanese Unexamined Patent Application Publication No. 2019-118221 (JP 2019-118221 A).

### SUMMARY

In recent years, a power supply system has been devised that includes a first battery, a second battery, and a charging connector. This power supply system can perform parallel charging that charges the first battery via a first charging path and charges the second battery via a second charging path using power from charging equipment connected to the charging connector. When such a power supply system is performing the parallel charging while adjusting the temperature of the first battery and the temperature of the second battery using a temperature adjustment medium, actual power of auxiliary equipment connected to the first charging path may suddenly decrease and therefore charging power for the first battery may suddenly increase. In this case, the charging power for the first battery may exceed allowable input power of the first battery.

A primary object of a power supply system of the present disclosure is to reduce the possibility that charging power for a first battery may exceed allowable input power of the first battery when the power supply system is performing parallel charging while adjusting the temperature of the first battery and the temperature of a second battery using a temperature adjustment medium.

The power supply system of the present disclosure adopts the following measures in order to achieve the above primary object.

The power supply system of the present disclosure is a power supply system including a first battery and a second battery. The power supply system includes: a motor including a three-phase coil;
a first inverter connected to the first battery via a first positive line and a negative line and connected to one end of the three-phase coil;
a second inverter connected to the second battery via a second positive line and the negative line and connected to another end of the three-phase coil;
a charging connector connected to the first positive line and the negative line, the charging connector being electrically connectable to charging equipment;
auxiliary equipment connected to the first positive line and the negative line;
a temperature adjustment device configured to adjust a temperature of the first battery and a temperature of the second battery using a temperature adjustment medium; and
a control device configured to, when performing parallel charging that charges the first battery and the second battery with power from the charging equipment, control the first inverter and the second inverter in such a manner that the first battery is charged within a range of first allowable input power that is based on a first temperature of the first battery and the second battery is charged within a range of second allowable input power that is based on a second temperature of the second battery.

The temperature adjustment device is configured to have a higher temperature adjustment capability for the first battery than for the second battery.

The power supply system of the present disclosure includes: the temperature adjustment device configured to adjust the temperature of the first battery and the temperature of the second battery using the temperature adjustment medium; and the control device. The control device is configured to, when performing the parallel charging that charges the first battery and the second battery with the power from the charging equipment, control the first inverter and the second inverter in such a manner that the first battery is charged within the range of the first allowable input power that is based on the first temperature of the first battery and the second battery is charged within the range of the second allowable input power that is based on the second temperature of the second battery. In this case, the temperature adjustment device is configured to have a higher temperature adjustment capability for the first battery than for the second battery. Accordingly, the first temperature is more easily adjusted appropriately than the second temperature, so that the first allowable input power tends to be larger than the second allowable input power. This reduces the possibility that charging power for the first battery may exceed the first allowable input power in the case where actual power of the auxiliary equipment suddenly decreases and therefore the charging power for the first battery suddenly increases when the parallel charging is being performed while adjusting the temperature of the first battery and the temperature of the second battery using the temperature adjustment medium.

In the power supply system of the present disclosure, the temperature adjustment device may be configured to cause the temperature adjustment medium to flow through the first battery and the second battery in this order.

The temperature adjustment device may be configured in such a manner that a flow rate of the temperature adjustment medium that flows through the first battery is higher than a flow rate of the temperature adjustment medium that flows through the second battery.

In the power supply system of the present disclosure, the control device may be configured to, when performing the parallel charging, set common required power for the first battery and the second battery to a minimum value of the first allowable input power and the second allowable input power. The control device may be configured to set total required power to a sum of twice the common required power and power of the auxiliary equipment. The control device may be configured to request, from the charging equipment, the total required power or a total required current that is based on the total required power. The control device may also be configured to control the first inverter and the second inverter using the common required power or a current command for the second battery that is based on the common required power.

In the power supply system of the present disclosure,
a positive terminal of the first battery may be connected to the first positive line,
a negative terminal of the second battery may be connected to the negative line,
the power supply system may further include: a series line connecting a negative terminal of the first battery and a positive terminal of the second battery; a series relay attached to the series line; a parallel line connecting the series line at a position closer to the first battery than the series relay and the negative line; a first parallel relay attached to the parallel line; and a second parallel relay attached to the second positive line, and
in the parallel charging, the series relay may be turned off and the first parallel relay and the second parallel relay may be turned on to connect the first battery and the second battery in parallel as viewed from the charging connector, and the first battery and the second battery may be charged with the power from the charging equipment.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a power supply system 10 and a charging stand 80 according to an embodiment of the present disclosure;

FIG. 2 is an explanatory diagram illustrating a current flow in parallel charging;

FIG. 3 is a flow chart illustrating an exemplary process routine executed by a system ECU 50; and

FIG. 4 is a schematic configuration diagram of a power supply system 110 and a charging stand 80 according to a modification.

### DETAILED DESCRIPTION OF EMBODIMENTS

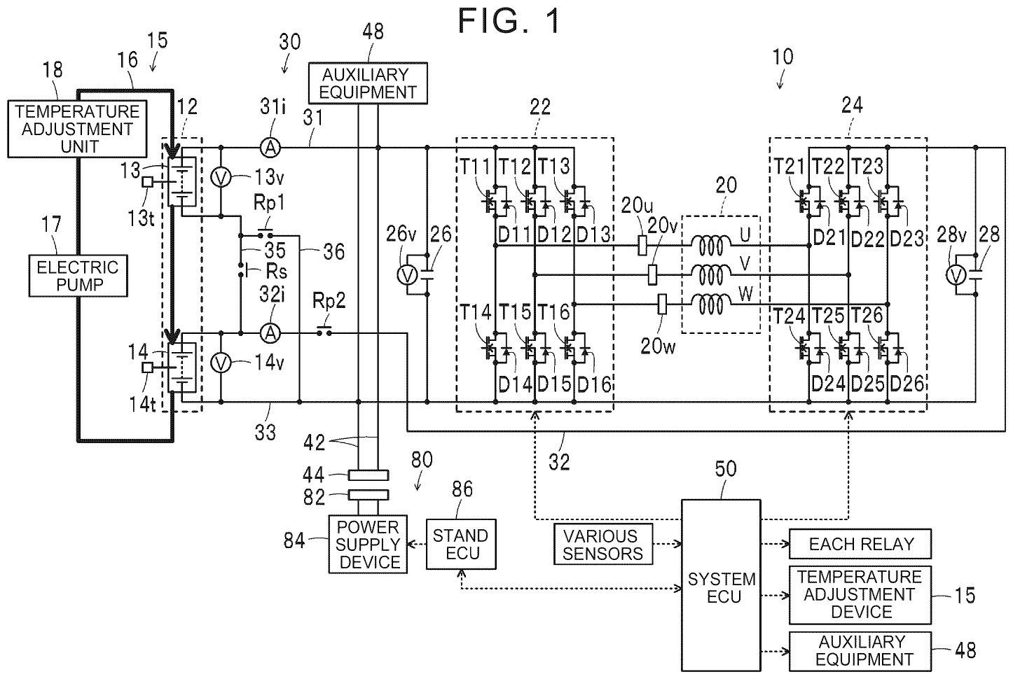

Embodiments for carrying out the present disclosure will be described with reference to the drawings. FIG. 1 is a schematic configuration diagram of a power supply system 10 and a charging stand 80 according to an embodiment of the present disclosure. The power supply system 10 is mounted on a battery electric vehicle or a hybrid electric vehicle, and includes a battery 12, a temperature adjustment device 15, a motor 20, a first inverter 22, a second inverter 24, a switching circuit 30, a charging circuit 40, auxiliary equipment 48, and a system electronic control unit (hereinafter referred to as “system ECU”) 50 as a control device. The power supply system 10 is capable of charging the battery 12 using power from a charging stand 80 installed at a home, a charging station, etc.

The battery 12 includes a first battery 13 and a second battery 14 as the first battery and the second battery. The first battery 13 and the second battery 14 are each configured as, for example, a lithium-ion secondary battery or a nickel-metal hydride secondary battery whose rated voltage is slightly lower than the first voltage Vs1 (for example, 400 V). In the embodiment, the first battery 13 and the second battery 14 have the same specifications. The positive terminal of the first battery 13 is connected to the first positive line 31, and the negative terminal of the second battery 14 is connected to the negative line 33. The negative terminal of the first battery 13 is connected to the positive terminal of the second battery 14 via the series line 35. A series relay Rs is attached to the series line 35. Therefore, the first battery 13 and the second battery 14 are connected in series to each other by turning on the series relay Rs.

The temperature adjustment device 15 includes a circulation flow path 16, an electric pump 17, and a temperature adjustment unit 18. The circulation flow path 16 is a flow path for circulating the temperature adjustment medium (for example, coolant) in the order of the electric pump 17, the temperature adjustment unit 18, the first battery 13, the second battery 14, and the electric pump 17. The electric pump 17 pumps the temperature adjustment medium in the circulation flow path 16. The temperature adjustment unit 18 cools the temperature adjustment medium using a refrigeration cycle including a compressor, a condenser, an expansion valve, and an evaporator, and heats the temperature adjustment medium using a heater.

The motor 20 is configured as a three-phase AC motor having, for example, a rotor in which a permanent magnet is embedded in a rotor core, and a stator in which a three-phase (U-phase, V-phase, and W-phase) coil is wound around the stator core. The first inverter 22 includes six transistors T11 to T16 as switching elements, and six diodes D11 to D16 connected in parallel to each of the six transistors T11 to T16. The transistors T11 to T16 are arranged in pairs of two, one on the source side and the other on the sink side with respect to the first positive line 31 and the negative line 33, respectively. Each of the connecting points of every two of transistors T11 to T16 that form a pair is connected to one end of a three-phase (U-phase, V-phase, and W-phase) coil of the motor 20. A smoothing first capacitor 26 is connected to the first positive line 31 and the negative line 33. Like the first inverter 22, the second inverter 24 includes six transistors T21 to T26 as switching elements and six diodes D21 to D26. The transistors T21 to T26 are arranged in pairs of two, one on the source side and the other on the sink side with respect to the second positive line 32 and the negative line 33, respectively. Each of the connecting points of every two of transistors T21 to T26 that form a pair is connected to another end of the three-phase (U-phase, V-phase, and W-phase) coil of the motor 20. A smoothing second capacitor 28 is connected to the second positive line 32 and the negative line 33. Hereinafter, the transistors T11 to T13, T21 to T23 of the first and second inverters 22, 24 will be sometimes referred to as “upper arms”, and the transistors T14 to T16, T24 to T26 will be sometimes referred to as “lower arms”.

In addition to the first positive line 31, the second positive line 32, the negative line 33, the series line 35, and the series relay Rs, the switching circuit 30 includes a parallel line 36, a first parallel relay Rp1, and a second parallel relay Rp2. The parallel line 36 connects the negative terminal of the first battery 13 and the negative line 33. The first parallel relay Rp1 is attached to the parallel line 36. The second parallel relay Rp2 is attached to the second positive line 32.

The charging circuit 40 includes a charging line 42 connected to the first positive line 31 and the negative line 33, and a charging connector 44 connected to the charging line 42. The charging connector 44 is configured to be connectable to a stand connector 82 of the charging stand 80.

The auxiliary equipment 48 is connected to the first positive line 31 and the negative line 33. Examples of the auxiliary equipment 48 include an air compressor of an air conditioner.

The system ECU 50 includes a CPU, a ROM, a RAM, a flash memory, an input and output port, a microcomputer having a communication port, various driving circuits, and various logic IC. The system ECU 50 receives signals from various sensors. Examples of the various sensors include a voltage sensor 13v that detects a voltage Vb1 of the first battery 13, a temperature sensor 13t that detects a temperature Tb1 of the first battery 13, a voltage sensor 14v that detects a voltage Vb2 of the second battery 14, and a temperature sensor 14t that detects a temperature Tb2 of the second battery 14. Other examples of the various sensors include a rotational position sensor 20a for detecting a rotational position of the rotor of the motor 20, current sensors 20u, 20v, and 20w for detecting currents Iu, Iv, and Iw flowing in each phase (U-phase, V-phase, and W-phase) of the motor 20, a voltage sensor 26v for detecting a voltage VH of the first capacitor 26, and a voltage sensor 28v for detecting a voltage VL of the second capacitor 28 are also exemplified. Still other examples of the various sensors include a current sensor 31i for detecting a current Ip1 flowing through the first positive line 31 and a current sensor 32i for detecting a current Ip2 flowing through the second positive line 32. There is a case where the series relay Rs is off and the first parallel relay Rp1 and the second parallel relay Rp2 are on. That is, the first battery 13 may be connected to the first positive line 31 and the negative line 33, and the second battery 14 may be connected to the second positive line 32 and the negative line 33. At this time, the current Ip1 flowing through the first positive line 31 is equal to the current flowing through the first battery 13. The current Ip2 flowing through the second positive line 32 is equal to the current flowing through the second battery 14. There is also a case where the series relay Rs is on and the first parallel relay Rp1 and the second parallel relay Rp2 are off. That is, the first battery 13 and the second battery 14 may be connected in series. At this time, the current Ip1 flowing through the first positive line 31 is equal to the current flowing through the first battery 13 and the second battery 14.

The system ECU 50 calculates the states of charge SOC1, SOC2, open-circuit voltages OCV1, OCV2, and allowable input powers Win1, Win2 of the first battery 13 and the second battery 14. The states of charge SOC1, SOC2 are calculated, for example, based on the integrated value of the current Ip1 (current flowing through the first battery 13) flowing through the first positive line 31 and the integrated value of the current Ip2 (current flowing through the second battery 14) flowing through the second positive line 32 when the series relay Rs is off and the first parallel relay Rp1 and the second parallel relay Rp2 are on. Alternatively, it is calculated based on the integrated value of the current Ip1 (current flowing through the first battery 13 and the second battery 14) flowing through the first positive line 31 when the series relay Rs is on and the first parallel relay Rp1 and the second parallel relay Rp2 are off. The open-circuit voltages OCV1, OCV2 are derived, for example, by applying the states of charge SOC1, SOC2 to a map determined in advance by experimentation, analysis, machine learning, etc. as a relationship between the states of charge SOC1, SOC2 and the open-circuit voltages OCV1, OCV2. The allowable input powers Win1, Win2 are derived by, for example, applying the states of charge SOC1, SOC2 and the temperatures Tb1, Tb2 to the map. The map is determined in advance by experimentation, analysis, machine learning, or the like as a relation between the states of charge SOC1, SOC2, the temperatures Tb1, Tb2, and the allowable input powers Win1, Win2. The allowable input powers Win1, Win2 are set to be constant when the temperatures Tb1, Tb2 are within the normal temperature range (predetermined temperature range) for each value of the states of charge SOC1, SOC2. The allowable input powers Win1, Win2 are set so as to decrease as the temperatures Tb1, Tb2 decrease when the temperatures Tb1, Tb2 are lower than the lower limit of the normal temperature range. The allowable input powers Win1, Win2 are set so as to decrease as the temperatures Tb1, Tb2 increase when the temperatures Tb1, Tb2 are higher than the upper limit of the normal temperature range.

The system ECU 50 outputs control signals to the temperature adjustment device 15 (electric pump 17, refrigeration cycle, heater, etc.), the first and second inverters 22, 24, and the relays, and control signals to the auxiliary equipment 48. Examples of the relays include a series relay Rs, a first parallel relay Rp1, and a second parallel relay Rp2. The system ECU 50 can communicate with a stand electronic control unit (hereinafter, referred to as “stand ECU”) 86 of the charging stand 80.

The charging stand 80 includes the stand connector 82, a power supply device 84, and the stand ECU 86. The stand connector 82 is configured to be connectable to the charging connector 44 of the power supply system 10. The power supply device 84 is connected to an AC power source such as a household power source or a commercial power source, and is configured to be capable of converting AC power from the AC power source into DC power and adjusting output power (output voltage and output current) so as to be output to the stand connector 82 side. The stand ECU 86 includes a microcomputer like the system ECU 50. The stand ECU 86 receives signals of various sensors. Examples of the various sensors include a voltage sensor (not shown) that detects an output voltage Vs of the power supply device 84, and a current sensor (not shown) that detects an output current Is of the power supply device 84. A control signal to the power supply device 84 is outputted from the stand ECU 86. The stand ECU 86 can communicate with the system ECU 50 as described above. Examples of the charging stand 80 include a first voltage stand that supplies power at a first voltage Vs1 (for example, 400 V), a second voltage stand that supplies power at a second voltage Vs2 (for example, 800 V) higher than the first voltage Vs1, and a third voltage stand that supplies power at a voltage that can be selectively set to either the first voltage Vs1 or the second voltage Vs2.

In the power supply system 10 of the embodiment configured as described above, when the motor 20 is driven as the driving motor, the first battery 13 and the second battery 14 are connected in series by turning on the series relay Rs and turning off the first parallel relay Rp1 and the second parallel relay Rp2. Further, the motor 20 is driven by the first inverter 22 by using electric power from the first battery 13 and the second battery 14.

In the power supply system 10, the charging connector 44 and the stand connector 82 of the charging stand 80 are sometimes connected. At this time, the system ECU 50 selects parallel charging when the voltage of the supply power of the charging stand 80 is the first voltage Vs1, and selects series charging when the voltage of the supply power of the charging stand 80 is the second voltage Vs2.

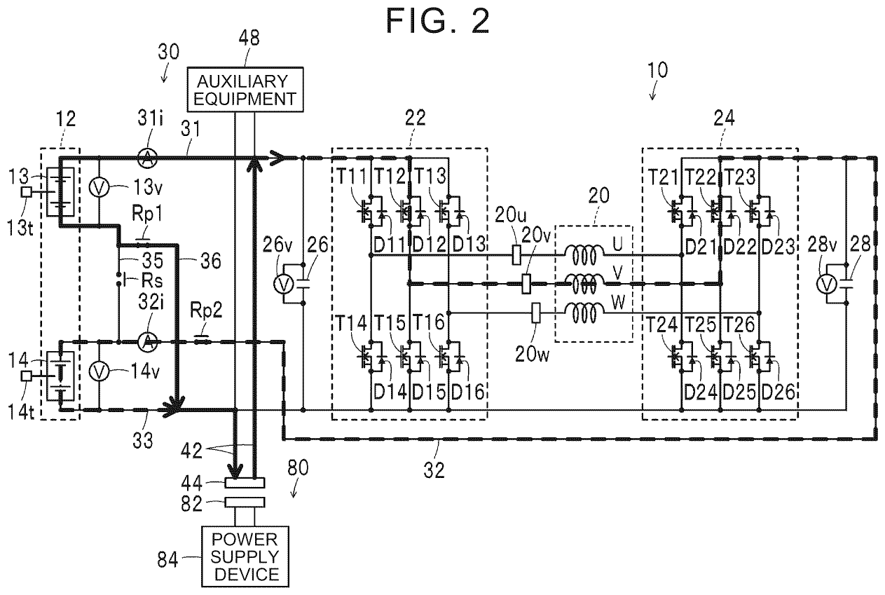

In parallel charging, the first battery 13 and the second battery 14 are connected in parallel as viewed from the charging connector 44 by turning off the series relay Rs and turning on the first parallel relay Rp1 and the second parallel relay Rp2. Electric power from the charging stand 80 is used to charge the first battery 13 and the second battery 14. FIG. 2 is an illustration of a current flow during parallel charging. In the figure, a thick solid line with an arrow indicates a charging current of the first battery 13, and a thick broken line with an arrow indicates a charging current of the second battery 14. In the parallel charging, the first battery 13 is charged by a current flowing from the charging connector 44 to the positive line of the charging line 42, the first positive line 31, the first battery 13, the parallel line 36 (first parallel relay Rp1), the negative line 33, the negative line of the charging line 42, and the charging connector 44 in this order, as shown by a thick solid line with an arrow in FIG. 2. The second battery 14 is charged by a current flowing in the order of the positive line of the charging line 42, the first positive line 31, the first inverter 22, the motor 20, the second inverter 24, the second positive line 32 (second parallel relay Rp2), the second battery 14, the negative line 33, the negative line of the charging line 42, and the charging connector 44 from the charging connector 44, as shown by the thick broken line with arrows in FIG. 2. At this time, the upper arm of the second inverter 24 is fixed on (lower arm is fixed to off). At the same time, by performing step-down control for controlling the duty cycle of the upper arm and lower arm of the first inverter 22, the motor 20 and the first inverter 22 function as a three-phase buck converter, and the input power of the first inverter 22 is stepped down and output from the motor 20. The upper arm of the first inverter 22 is fixed to on (lower arm is fixed to off). At the same time, by performing step-up control for controlling the duty cycle of the upper arm and lower arm of the second inverter 24, the motor 20 and the second inverter 24 function as a three-phase boost converter, and the input power of the motor 20 is boosted and output from the second inverter 24.

In the series charging, the first battery 13 and the second battery 14 are connected in series by turning on the series relay Rs and turning off the first parallel relay Rp1 and the second parallel relay Rp2, and the first battery 13 and the second battery 14 are charged using the electric power from the charging stand 80. In the series charging, the first battery 13 and the second battery 14 are charged by the current flowing from the charging connector 44 to the positive line of the charging line 42, the first positive line 31, the first battery 13, the series line 35 (series relay Rs), the second battery 14, the negative line 33, the negative line of the charging line 42, and the charging connector 44 in this order.

When either of the temperatures Tb1, Tb2 of the first and second batteries 13, 14, whichever is lower, is lower than the threshold Tblo during parallel charging or series charging, the power supply system 10 of the embodiment operates the temperature adjustment device 15 to raise the temperatures of the first and second batteries 13, 14. As the threshold Tblo, for example, a lower limit of a normal temperature range, a temperature slightly lower than the lower limit, etc. is used. When either of the temperature Tb1, Tb2 of the first and second batteries 13, 14, whichever is higher, is higher than the threshold Vbhi that is higher than the threshold Tblo to some extent, the temperature adjustment device 15 is operated to cool the first and second batteries 13, 14. As the threshold Tbhi, for example, an upper limit of a normal temperature range, a temperature slightly higher than the upper limit, or the like is used.

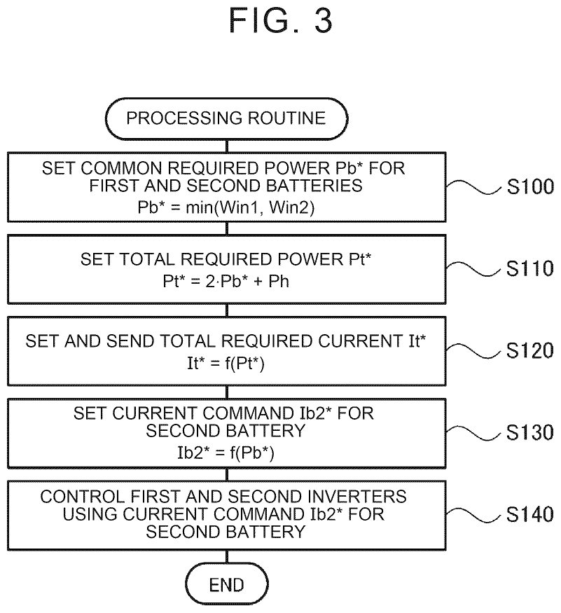

Next, the operation of the power supply system 10 of the embodiment, in particular, the operation at the time of parallel charging will be described. FIG. 3 is a flowchart illustrating a process routine that is executed by the system ECU 50. This routine is repeatedly executed during parallel charging. The series relay Rs is turned off and the first parallel relay Rp1 and the second parallel relay Rp2 are turned on prior to the repetition of the routine.

When the process routine of FIG. 3 is executed, the system ECU 50 first sets common required power Pb*, namely common required power for the first battery 13 and the second battery 14, to a minimum value of the allowable input powers Win1, Win2 of the first battery 13 and the second battery 14 (S100). The system ECU 50 then sets total required power Pt* to the sum of twice the common required power Pb* and the power Ph of the auxiliary equipment 48 (S110). The system ECU 50 sets a total required current It* based on the set total required power Pt*, and sends it to the stand ECU 86 of the charging stand 80 (S120). The total required current It* is calculated, for example, by dividing the total required power Pt* by the output voltage Vs of the power supply device 84, or by dividing the total required power Pt* by the maximum value of the voltages Vb1, Vb2 of the first battery 13 and the second battery 14. Upon receiving the total required current It*, the stand ECU 86 controls the power supply device 84 so that a current corresponding to the total required current It* is supplied from the charging stand 80 to the power supply system 10.

The system ECU 50 then sets a current command Ib2* for the second battery 14 based on the common required power Pb* (S130). The system ECU 50 controls the first inverter 22 and the second inverter 24 based on the set current command Ib2* for the second battery 14 (S140), and ends the routine. The current command Ib2* is calculated, for example, by dividing the common required power Pb* by the voltage Vb2 of the second battery 14. Due to such control of the first inverter 22 and the second inverter 24, the second battery 14 is charged with a current corresponding to the current command Ib2* (power corresponding to the common required power Pb*) out of a current corresponding to the total required current It* from the charging stand 80 (power corresponding to the total required power Pt*, that is, power corresponding to the sum of twice the common required power Pb* and the power Ph of the auxiliary equipment 48), the first battery 13 is charged with the same current, and the power Ph is consumed by the auxiliary equipment 48. Therefore, it is possible to suppress a relatively large deviation between the charging current of the first battery 13 (current Ip1 flowing through the first positive line 31) and the charging current of the second battery 14 (current Ip2 flowing through the second positive line 32).

The control of the first inverter 22 and the second inverter 24 is performed, for example, as follows. When the open-circuit voltage OCV1 of the first battery 13 is higher than the open-circuit voltage OCV2 of the second battery 14, the step-down control is performed. As a result, part of the power from the charging stand 80 is stepped down by the first inverter 22 and the motor 20 and supplied to the second battery 14. Therefore, it is possible to suppress a relatively large deviation between the charging current of the first battery 13 and the charging current of the second battery 14. When the open-circuit voltage OCV1 of the first battery 13 is lower than the open-circuit voltage OCV2 of the second battery 14, the step-up control is performed. As a result, part of power from the charging stand 80 is boosted by the motor 20 and the second inverter 24 and supplied to the second battery 14. Therefore, it is possible to suppress a relatively large deviation between the charging current of the first battery 13 and the charging current of the second battery 14. When the open-circuit voltage OCV1 of the first battery 13 is equal to the open-circuit voltage OCV2 of the second battery 14, either the step-down control or the step-up control may be executed. In addition, both of the upper arms of the first inverter 22 and the second inverter 24 may be fixed to on (both of the lower arms may be fixed to off). In the latter case, a part of the electric power from the charging stand 80 is supplied to the second battery 14 without being voltage converted by the first inverter 22, the motor 20, and the second inverter 24, and it is possible to suppress a relatively large deviation between the charging current of the first battery 13 and the charging current of the second battery 14. Note that the voltage Vb1 of the first battery 13 and the voltage Vb2 of the second battery 14 may be used instead of the open-circuit voltage OCV1 of the first battery 13 and the open-circuit voltage OCV2 of the second battery 14.

In the embodiment, when the temperature adjustment device 15 heats or cools the first battery 13 and the second battery 14, the temperature adjustment medium flows through the first battery 13 and the second battery 14 in this order. Therefore, the temperature Tb1 of the first battery 13 is more likely to approach the normal temperature range than the temperature Tb2 of the second battery 14. The allowable input power Win1 of the first battery 13 tends to be larger than the allowable input power Win2 of the second battery 14. Therefore, the total required power Pt*, i.e., the sum of twice the common required power Pb* and the power Ph of the auxiliary equipment 48, tends to be the sum of twice the allowable input power Win2 and the power Ph of the auxiliary equipment 48. This reduces the possibility that the charging power for the first battery 13 may exceed the allowable input power Win1 in the case where the actual power of the auxiliary equipment 48 suddenly decreases as a result of stopping the auxiliary equipment 48 and therefore the charging power for the first battery 13 suddenly increases when the parallel charging is being performed while heating or cooling the first battery 13 and the second battery 14 by the temperature adjustment device 15.

In the power supply system 10 of the embodiment described above, the temperature adjustment device 15 is configured such that the temperature adjustment medium flows through the first battery 13 and the second battery 14 in this order. Accordingly, when the temperature of the first battery 13 and the temperature of the second battery 14 are increased or cooled, the allowable input power Win1 of the first battery 13 tends to be larger than the allowable input power Win2 of the second battery 14. This reduces the possibility that charging power for the first battery 13 may exceed the allowable input power Win1 in the case where the actual power of the auxiliary equipment 48 suddenly decreases and therefore the charging power for the first battery 13 suddenly increases when the parallel charging is being performed while heating or cooling the first battery 13 and the second battery 14 using the temperature adjustment device 15.

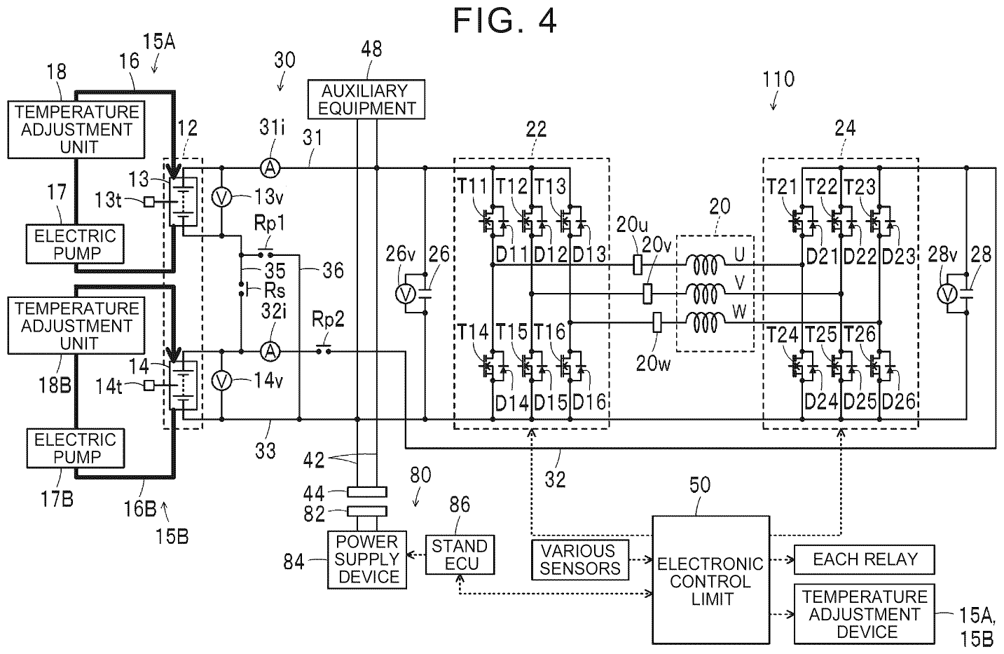

In the above embodiment, the temperature adjustment device 15 is configured such that the temperature adjustment medium flows through the first battery 13 and the second battery 14 in this order, but the present disclosure is not limited thereto. The temperature adjustment device 15 need only be configured to have a higher temperature adjustment capability for the first battery 13 than for the second battery 14. For example, temperature adjustment devices 15A, 15B may be provided as in the power supply system 110 of the modification in FIG. 4. The temperature adjustment devices 15A, 15B includes circulation flow paths 16A, 16B, electric pumps 17A, 17B, and temperature adjustment units 18A, 18B, respectively. The circulation flow path 16A is a flow path for circulating the temperature adjustment medium (for example, coolant) in the order of the electric pump 17A, the temperature adjustment unit 18A, the first battery 13, and the electric pump 17A. The circulation flow path 16B is a flow path for circulating the temperature adjustment medium (for example, coolant) in the order of the electric pump 17B, the temperature adjustment unit 18B, the second battery 14, and the electric pump 17B. The electric pump 17A, 17B and the temperature adjustment unit 18A, 18B are configured in the same manner as the electric pump 17 and the temperature adjustment unit 18, respectively. The temperature adjustment devices 15A, 15B are configured so that the flow rate of the temperature adjustment medium that flows through the first battery 13 is higher than the flow rate of the temperature adjustment medium that flows through the second battery 14 due to a difference between at least one of the following: between the circulation flow path 16A and the circulation flow path 16B, between the electric pump 17A and the electric pump 17B, and between the temperature adjustment unit 18A and the temperature adjustment unit 18B. Even in the power supply system 10 configured in this way, when the first battery 13 and the second battery 14 are heated or cooled by the temperature adjustment devices 15A, 15B, the allowable input power Win1 of the first battery 13 is made larger than the allowable input power Win2 of the second battery 14, whereby the same advantages as those of the above embodiment can be obtained.

In the above embodiment, the total required current It* based on the total required power Pt* is sent to the stand ECU 86 during parallel charging. However, the present disclosure is not limited to this. For example, the total required power Pt* may be sent to the stand ECU 86 during parallel charging. When the stand ECU 86 receives the total required power Pt*, it controls the power supply device 84 such that the power corresponding to the total required power Pt** is supplied from the charging stand 80 to the power supply system 10.

In the above embodiment, when performing parallel charging, the first inverter 22 and the second inverter 24 are controlled using the current command Ib2* for the second battery 14 that is based on the common required power Pb* of the first battery 13 and the second battery 14. However, the present disclosure is not limited to this. The first inverter 22 and the second inverter 24 need only be controlled so that the first battery 13 is charged within the allowable input power Win1 of the first battery 13 and the second battery 14 is charged within the allowable input power of the second battery 14 during parallel charging.

In the above embodiment, when performing parallel charging, the first inverter 22 and the second inverter 24 are controlled using the current command Ib2* for the second battery 14 that is based on the common required power Pb* of the first battery 13 and the second battery 14. However, the present disclosure is not limited to this. For example, the first inverter 22 and the second inverter 24 may be controlled by directly using the common required power Pb* (without using the current command Ib2*).

The correspondence between the main elements of the embodiments and the main elements of the disclosure described in the column of the means for solving the problem will be described. In the embodiment, the first battery 13 corresponds to the “first battery”, the second battery 14 corresponds to the “second battery”, and the motor 20 corresponds to the “motor”. The first inverter 22 corresponds to the “first inverter”, the second inverter 24 corresponds to the “second inverter”, and the charging connector 44 corresponds to the “charging connector”. The auxiliary equipment 48 corresponds to the “auxiliary equipment”, the temperature adjustment device 15 corresponds to the “temperature adjustment device”, and the system ECU 50 corresponds to the “control device”. Further, the series line 35 corresponds to the “series line”, and the series relay Rs corresponds to the “series relay”. The parallel line 36 corresponds to the “parallel line”, the first parallel relay Rp1 corresponds to the “first parallel relay”, and the second parallel relay Rp2 corresponds to the “second parallel relay”.

The correspondence between the main elements of the embodiment and the main elements of the disclosure described in the section of the means for solving the problem is an example for specifically explaining the embodiment of the disclosure described in the section of the means for solving the problem. Therefore, the embodiments of the present disclosure are not intended to limit the elements of the disclosure described in the section of the means for solving the problem. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to the manufacturing industry of power supply systems etc.

What is claimed is:

1. A power supply system including a first battery and a second battery, the power supply system comprising:
a motor including a three-phase coil;
a first inverter connected to the first battery via a first positive line and a negative line and connected to one end of the three-phase coil;
a second inverter connected to the second battery via a second positive line and the negative line and connected to another end of the three-phase coil;
a charging connector connected to the first positive line and the negative line, the charging connector being electrically connectable to charging equipment;
auxiliary equipment connected to the first positive line and the negative line;
a temperature adjustment device configured to adjust a temperature of the first battery and a temperature of the second battery using a temperature adjustment medium; and
a control device configured to, when performing parallel charging that charges the first battery and the second battery with power from the charging equipment, control the first inverter and the second inverter in such a manner that the first battery is charged within a range of first allowable input power that is based on a first temperature of the first battery and the second battery is charged within a range of second allowable input power that is based on a second temperature of the second battery,
wherein the temperature adjustment device is configured to have a higher temperature adjustment capability for the first battery than for the second battery.

2. The power supply system according to claim 1, wherein the temperature adjustment device is configured to cause the temperature adjustment medium to flow through the first battery and the second battery in this order.

3. The power supply system according to claim 1, wherein the temperature adjustment device is configured in such a manner that a flow rate of the temperature adjustment medium that flows through the first battery is higher than a flow rate of the temperature adjustment medium that flows through the second battery.

4. The power supply system according to claim 1, wherein:
a positive terminal of the first battery is connected to the first positive line;
a negative terminal of the second battery is connected to the negative line;
the power supply system further includes:
a series line connecting a negative terminal of the first battery and a positive terminal of the second battery;
a series relay attached to the series line;
a parallel line connecting the series line at a position closer to the first battery than the series relay and the negative line;
a first parallel relay attached to the parallel line; and
a second parallel relay attached to the second positive line; and
in the parallel charging, the series relay is turned off and the first parallel relay and the second parallel relay are turned on to connect the first battery and the second battery in parallel as viewed from the charging connector, and the first battery and the second battery are charged with the power from the charging equipment.
